(19) United States
(12) Patent Application Publication
(10) Pub. No.: US 2014/0241559 A1
(43) Pub. Date: Aug. 28, 2014

(54) MICROPHONE ASSEMBLY

(71) Applicant: Hans Mülder, Wuennewil (CH)

(72) Inventor: Hans Mülder, Wuennewil (CH)

(21) Appl. No.: 14/352,721

(22) PCT Filed: Oct. 19, 2011
(86) PCT No.: PCT/EP2011/068233

§ 371 Date: Apr. 18, 2014

(51) Int. Cl. H04R 1/04

(52) U.S. Cl. CPC H04R 1/04
USPC 381/355

(57) ABSTRACT

A mobile microphone assembly (10) has at least one microphone (40, 42) for generating an audio signal output (52) from sound impinging on the least one microphone, an acceleration sensor (48) for sensing the acceleration acting on the microphone assembly with regard to three orthogonal axes and for providing for an acceleration signal according to the sensed acceleration, and a control unit (50) for judging, by analyzing the acceleration signal, whether there is a drop-down event of the microphone assembly and for interrupting the audio signal output during a drop-down event.

### BACKGROUND OF THE INVENTION

1. Field of the Invention

The invention relates to a mobile microphone assembly and to a method for capturing audio signals from sound by using such microphone assembly.

2. Description of Related Art

Mobile microphones, such as hand-held microphones, are used for picking up sound, typically a person's voice. In general, microphones may supply the audio signal via a wired connection or via a wireless link to the audio signal receiving system.

Mobile microphones are used in many different applications, for example in systems for speech enhancement in a room, see, for example, International Patent Application Publication WO 2011/027005 A2, or as a wireless microphone in hearing assistance systems, wherein the audio signals captured by the microphone are transmitted via a wireless link to body-worn or ear level receiver units in order to supply the audio signals to an ear-worn device, such as a hearing aid, see for example International Patent Application Publication WO 2011/098140 A1. Other applications of mobile microphones include tour-guiding, TV, broadcast, audio studio and stage presentation.

For example, in hearing assistance systems wireless microphones are used by teachers teaching hearing impaired persons in a classroom (wherein the audio signals captured by the wireless microphone of the teacher are transmitted to a plurality of receiver units worn by the hearing impaired persons listening to the teacher) or in cases where several persons are speaking to a hearing impaired person (for example, in a professional meeting, wherein each speaker is provided with a wireless microphone and with the receiver units of the hearing impaired person receiving audio signals from all wireless microphones). Another example is audio tour guiding, wherein the guide uses a wireless microphone. In all of these cases wireless hand held pass around microphones can be used, for instance by children in a classroom when answering a question from the teacher, in professional meetings where a pass around microphone can be used for questions and answers and in tour guiding, where visitors can ask the tour-guide a question through the pass around microphone.

Another application of wireless audio systems is the case in which the transmission unit is designed as an assistive listening device. In this case, the transmission unit may include a wireless microphone for capturing ambient sound, in particular from a speaker close to the user, and/or a gateway to an external audio device, such as a mobile phone; here the transmission unit usually only serves to supply wireless audio signals to the receiver unit(s) worn by the user.

Generally, it may happen that a mobile microphone falls down on a hard surface, such as the floor, whereupon the microphone, when dropping on a hard surface, picks up the mechanical shock of the landing. Thereby an audio signal is produced which, when amplified by the audio system to which the microphone audio signals are supplied to, may at best result in unwanted and uncomfortable sound and at worst in dangerously loud sound which may distract attention of the listeners.

German Patent Application DE 10 2006 028 682 A1 relates to a hearing aid comprising a MEMS sensor acting as an accelerometer, wherein the sensor output is used for control of the hearing aid function. In particular, the directivity of the hearing aid microphones is controlled according to the motion of the hearing aid as detected by the MEMS sensor.

U.S. Patent Application Publication US 2009/0097683 A1, likewise, relates to a hearing aid comprising a MEMS sensor acting as an accelerometer, wherein the accelerometer is used for detecting user activities from the motion of the hearing aid in order to adjust the hearing aid function, such as the frequency response, to the detected user activities.

U.S. Patent Application Publication US 2009/0257608 A1 and corresponding U.S. Pat. No. 8,175,305 B2 relate to a hearing aid comprising an accelerometer used as a drop safeguard, wherein the hearing aid settings are saved when high acceleration of the hearing aid is detected by the accelerometer, so that the hearing aid settings can be reconstructed later.

U.S. Patent Application Publication US 2001/0045464 A1 and corresponding U.S. Pat. No. 6,669,097 B2 relate to a hand-held barcode reader device provided with an accelerometer for shutting down the device when high acceleration is detected.

U.S. Patent Application Publication US 2010/0231383 A1 and corresponding U.S. Pat. No. 8,271,057 B2 relate to a mobile phone provided with an accelerometer in order to control the mobile phone according to the detected motion status. U.S. Patent Application Publication US 2010/0319434 A1 and corresponding U.S. Pat. No. 8,061,182 B2 relate to a mobile phone comprising a piezoelectric drop detector used for warranty purposes. U.S. Patent Application Publication US 2011/0194230 A1 and corresponding U.S. Pat. No. 8,330,305 B2 relate to a mobile phone comprising a drop detector for activating a drop protection system. U.S. Patent Application Publication US 2007/0253087 A1 relates to a device, such as a mobile phone, comprising a hard disk drive and a free-fall detector for bringing the hard disk drive into a protection mode when free-fall of the device is detected. European Patent Application EP 2 211 319 A1 relates to a mobile phone comprising a drop detector for issuing an alert when a free-fall event is detected.

### SUMMARY OF THE INVENTION

It is an object of the invention to provide for a mobile microphone arrangement which avoids noise resulting from dropping of the microphone arrangement onto a hard surface. It is a further object to provide for a corresponding method of capturing audio signals from sound.

According to the invention, these objects are achieved by a microphone assembly and method as described herein.

The invention is beneficial in that, by providing the microphone assembly with an acceleration sensor and a control unit for interrupting the audio signal output of the microphone during a drop-down event as detected by the control unit by analyzing the acceleration signal provided by the acceleration sensor, in case of a free-fall the microphone is shut down automatically so that the microphone does not supply any audio signals corresponding the mechanical shock of the landing of the microphone arrangement on a hard surface. Thus, uncomfortable or even dangerously loud sound events to persons listening to sound reproduced from the microphone audio signals are avoided, whereby use comfort and use safety of the microphone assembly is enhanced.

Hereinafter, examples of the invention will be described with reference to the accompanying drawings.

### BRIEF DESCRIPTION OF THE DRAWINGS

FIG. 1 is a block diagram of an example of a microphone arrangement according to the invention;

FIGS. 2 to 4 are examples of the use of wireless hearing assistance systems using a microphone arrangement according to the invention;

FIG. 5 is a block diagram of a transmission unit which may be used in the systems of FIGS. 2 to 4;

FIG. 6 is a block diagram of a receiver unit which may be used in the systems of FIGS. 2 to 4; and

FIG. 7 is a block diagram of a speech enhancement system using a microphone arrangement according to the invention.

### DETAILED DESCRIPTION OF THE INVENTION

In FIG. 1, a schematic block diagram of an example of a mobile microphone assembly 10 is shown which comprises a microphone arrangement 44 having two spaced apart microphones 40, 42, an audio signal processing unit 46, an acceleration sensor 48 and a control unit 50. Each microphone 40, 42 generates an audio signal from sound impinging on the respective microphone 40, 42, which is supplied to the audio signal processing unit 46 for being processed. Such audio signal processing may include, for example, acoustic beam forming, pre-amplification, equalizing, feedback cancelling, and automatic gain control. Processed audio signals are supplied as audio signal output 52 by the audio signal processing unit 46.

The acceleration sensor 48 is capable of sensing the acceleration acting on the microphone assembly 10 with regard to three orthogonal axes and provides for an acceleration signal according to the sensed acceleration, which signal is supplied as input to the control unit 50. Such sensors are available in sufficiently small sizes to be integrated within the housing of a microphone assembly. The control unit 50 analyzes the acceleration signal in order to judge whether there is a drop-down (freefall) event of the microphone assembly 10. The control unit 50 interrupts the audio signal output 52 during a drop down event (i.e., once it has detected that there is a drop down event) by supplying a corresponding control signal to the audio signal processing unit 46. Since the acceleration sensor 48 is designed as a three-axis sensor, the orientation of the microphone assembly 10 at the onset of the free-fall does not need to be known.

Preferably, the control unit 50 is designed to judge that there is a drop down event once a given drop down threshold acceleration (for example 7 m/s²) is found to be exceeded by the acceleration signal for at least a given drop down time period (for example, 0.25 s, which is the time interval equivalent to a drop height of about 30 cm).

Interruption of the audio signal output may achieved, for example, by short-circuiting the wires of the microphones 40, 42. In case of a wireless system, as described hereinafter, interruption of the audio signal output also may be achieved by interrupting the transmission of audio signals. In general, such shut down of the microphones should occur as fast as possible once a drop down event has been detected by the control unit 50. In particular, shut down should be completed before the microphone assembly 10 actually hits the ground.

In order to reactivate the microphone assembly 10 after a drop down event, i.e., when the mechanical shock caused by the drop down has stopped, the control unit 10 preferably is designed to judge that the drop down event is terminated and to accordingly terminate interruption of the audio signal output 52 once a release acceleration threshold (for example 1 m/s²) is found to be not exceeded by the acceleration signal of the acceleration sensor 48 for at least a given release time period (for example 0.5 s). To this end, a corresponding control signal is supplied to the audio signal processing unit 46 from the control unit 50 once such termination of a drop down event has been detected.

Typically, the microphone assembly 10 is designed for capturing the voice of a user, and it is preferably designed as a hand-held device.

According to one embodiment, the microphone assembly may be designed as (i.e., integrated within) an audio signal transmission unit for transmitting the audio signal output 52 via a wireless link to at least one audio signal receiver unit or, according to a variant, the microphone assembly may be connected by wire to such an audio signal transmission unit, i.e., the microphone assembly 10 in these cases acts as a wireless microphone. Such wireless microphone may form part of a wireless hearing assistance system, wherein the audio signal receiver units are body-worn or ear level devices which supply the received audio signal to a hearing aid or other ear level hearing stimulation device. Such wireless microphone also may form part of a speech enhancement system in a room.

In such wireless audio systems, the device used on the transmission side may be, for example, a wireless microphone used by a speaker in a room for an audience or an audio transmitter having an integrated or a cable-connected microphone which are used by teachers in a classroom for hearing-impaired pupils/students. The devices on the receiver side include headphones, all kinds of hearing aids, ear pieces, such as for prompting devices in studio applications or for covert communication systems, and loudspeaker systems. The receiver devices may be for hearing-impaired persons or for normal-hearing persons. On the receiver side a gateway could be used which relays audio signal received via a digital link to another device comprising the stimulation means.

The system may include a plurality of devices on the transmission side and a plurality of devices on the receiver side, for implementing a network architecture, usually in a master-slave topology.

The receiver unit typically is connected to a hearing aid via an audio shoe or is integrated within a hearing aid.

In addition to the audio signals, control data is transmitted bi-directionally between the transmission unit and the receiver unit. Such control data may include, for example, volume control or a query regarding the status of the receiver unit or the device connected to the receiver unit (for example, battery state and parameter settings).

The wireless may be an analog FM link or it may be a digital link as described, for example in International Patent Application Publication WO 2011/098140 A1 and corresponding U.S. Patent Application Publication US2012/310394.

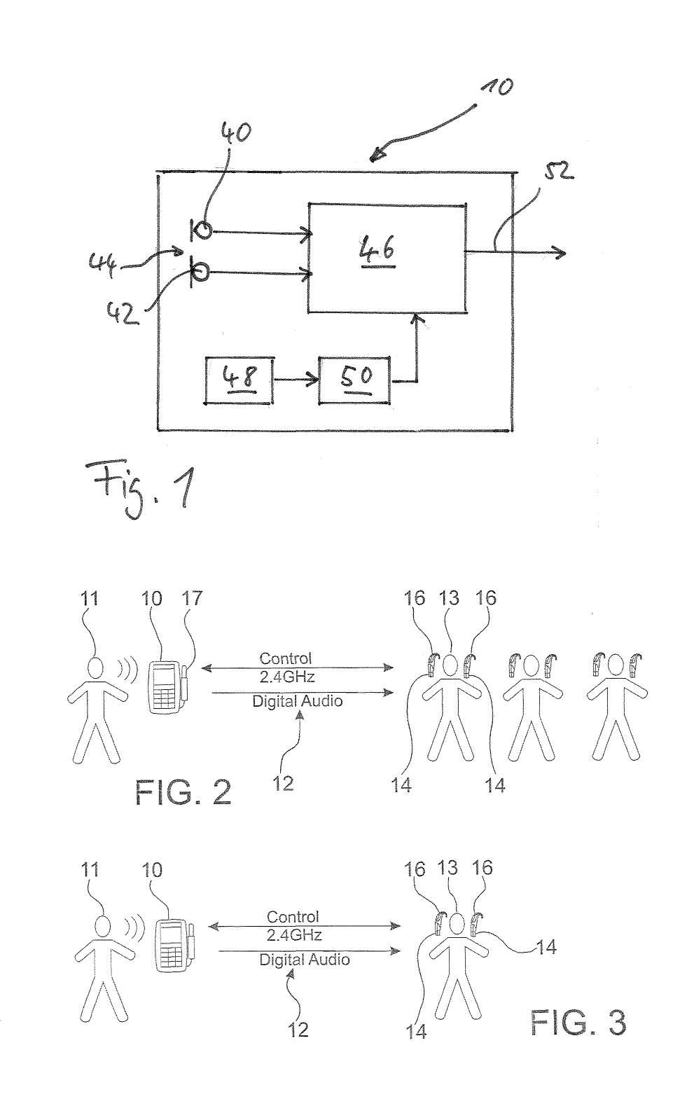

In FIG. 2, an example of an application of the invention is shown schematically, wherein a body-worn transmission unit 10, comprising a microphone 44, is used by a teacher 11 in a classroom for transmitting audio signals corresponding to the teacher's voice via a digital link 12 to a plurality of receiver units 14, which are integrated within or connected to hearing aids 16 worn by hearing-impaired pupils/students 13. The digital link 12 is also used to exchange control data between the transmission unit 10 and the receiver units 14. Typically, the transmission unit 10 is used in a broadcast mode, i.e., the same signals are sent to all receiver units 14.

Another use of the invention is shown in FIG. 3, wherein a transmission 10 having an integrated microphone is used by a hearing-impaired person 13 wearing receiver units 14 connected to or integrated within a hearing aid 16 for capturing the voice of a person 11 speaking to the person 13. The captured audio signals are transmitted via the digital link 12 to the receiver units 14.

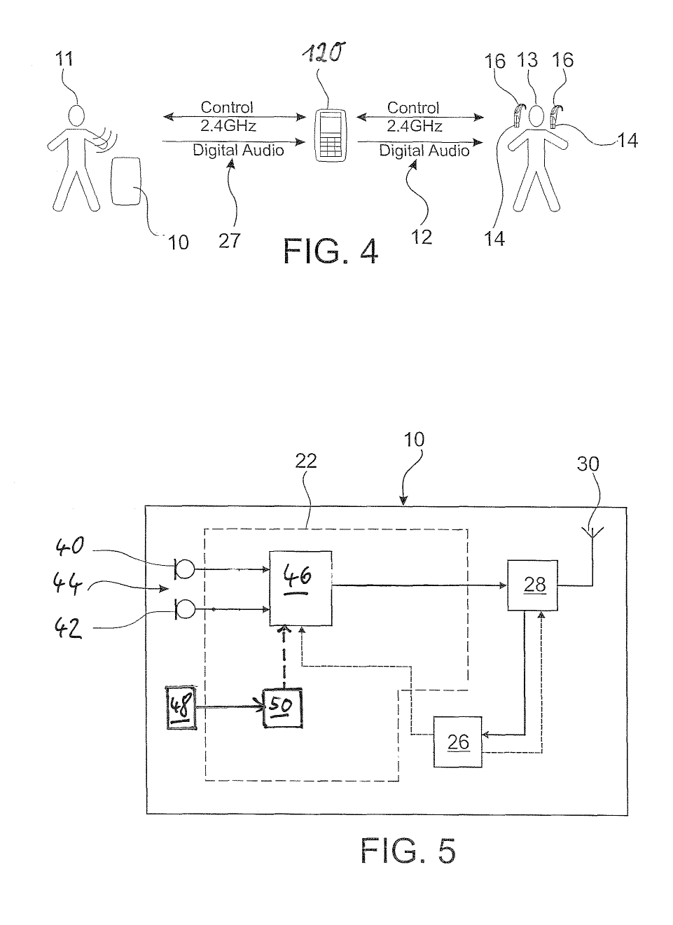

A modification of the use shown in FIG. 3 is shown in FIG. 4, wherein a transmission unit 120 is used as a relay for relaying audio signals received from a remote transmission unit 10 to the receiver units 14 of the hearing-impaired person 13. The remote transmission unit 10 is worn by a speaker 11 and comprises a microphone for capturing the voice of the speaker 11, thereby acting as a companion microphone.

According to a variant of the embodiments shown in FIGS. 2 to 4, the receiver units 14 could be designed as a neck-worn device comprising a transmitter for transmitting the received audio signals via an inductive link to an ear-worn device, such as a hearing aid.

The transmission units 10, 120 may comprise an audio input for a connection to an audio device, such as a mobile phone, a FM radio, a music player, a telephone or a TV device, as an external audio signal source.

In each of the above cases, the transmission unit 10 usually comprises an audio signal processing unit (not shown in FIGS. 2 to 4) for processing the audio signals captured by the microphone prior to being transmitted.

An example of a transmission unit 10 is shown in FIG. 5, which comprises a microphone arrangement 44 for capturing audio signals from the respective speaker's 11 voice, an audio signal processing unit 46 for processing the captured audio signals, an acceleration sensor 48, a control unit 50 for automatic shut-down during free-fall events of the transmission unit 10 as detected with the help of the acceleration sensor 48, a digital transmitter 28 and an antenna 30 for transmitting the processed audio signals as an audio stream 19 consisting of audio data packets. The audio signal processing unit 46 serves to compress the audio data using an appropriate audio codec which will be described in detail below. The compressed audio stream 19 forms part of a digital audio link 12 established between the transmission units 10 and the receiver unit 14, which link also serves to exchange control data packets between the transmission unit 10 and the receiver unit 14. The audio signal processing unit 46 and such additional components may be implemented by a digital signal processor (DSP) indicated at 22. In addition, the transmission units 10 also may comprise a microcontroller 26 acting on the DSP 22 and the transmitter 28. The microcontroller 26 may be omitted in case that the DSP 22 is able to take over the function of the microcontroller 26. Preferably, the microphone arrangement 44 comprises at least two spaced-apart microphones 40, 42, the audio signals of which may be used in the audio signal processing unit 46 for acoustic beamforming in order to provide the microphone arrangement 44 with a directional characteristic.

The control unit 50 may achieve interruption of the audio signal output during a drop-down event by causing the audio signal processing unit 46 to interrupt transmission of audio data, for example by causing the audio signal processing unit 46 to generate signals only which do not represent audio signals, such as signals consisting only of zeros, during a drop-down event.

In embodiments wherein the wireless link is an FM link the control unit 50 may achieve interruption of the audio signal output during a drop-down event by causing the FM transmitter to interrupt modulation of the carrier waves, i.e., to transmit only unmodulated carrier waves, during a drop-down event.

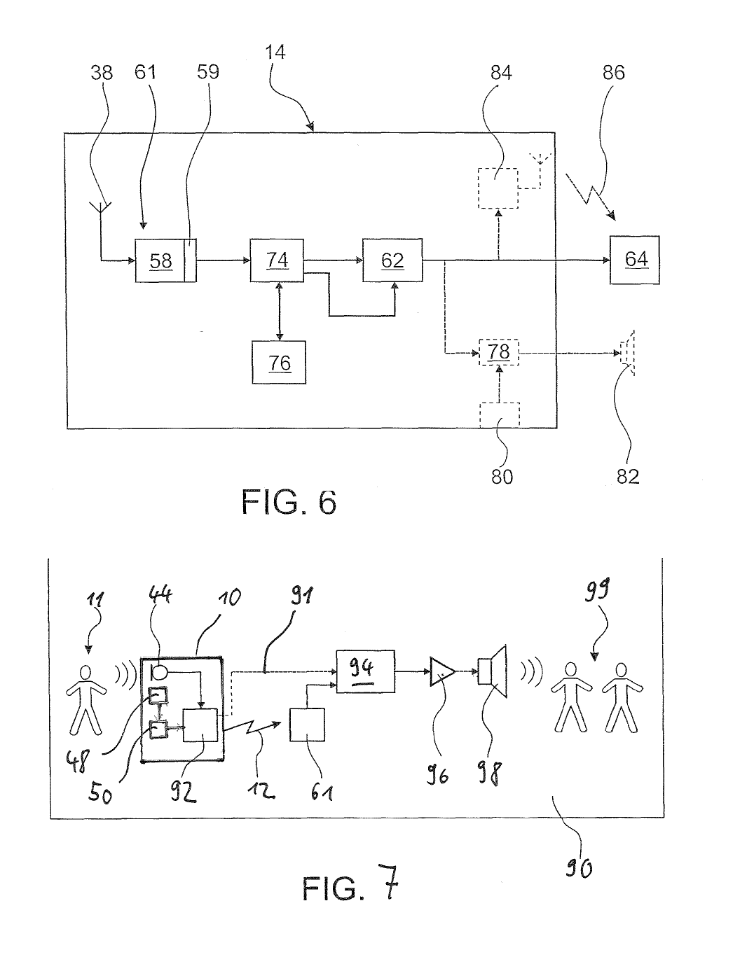

An example of a digital receiver unit 14 is shown in FIG. 6, according to which the antenna arrangement 38 is connected to a digital transceiver 61 including a demodulator 58 and a buffer 59. The signals transmitted via the digital link 12 are received by the antenna 38 and are demodulated in the digital radio receivers 61. The demodulated signals are supplied via the buffer 59 to a DSP 74 acting as processing unit which separates the signals into the audio signals and the control data and which is provided for advanced processing, e.g. equalization, of the audio signals according to the information provided by the control data. The processed audio signals, after digital-to-analog conversion, are supplied to a variable gain amplifier 62 which serves to amplify the audio signals by applying a gain controlled by the control data received via the digital link 12. The amplified audio signals are supplied to a hearing aid 64. The receiver unit 14 also includes a memory 76 for the DSP 74.

Rather than supplying the audio signals amplified by the variable gain amplifier 62 to the audio input of a hearing aid 64, the receiver unit 14 may include a power amplifier 78 which may be controlled by a manual volume control 80 and which supplies power amplified audio signals to a loudspeaker 82 which may be an ear-worn element integrated within or connected to the receiver unit 14. Volume control also could be done remotely from the transmission unit 10 by transmitting corresponding control commands to the receiver unit 14.

Another alternative implementation of the receiver maybe a neck-worn device having a transmitter 84 for transmitting the received signals via with an magnetic induction link 86 (analog or digital) to the hearing aid 64 (as indicated by dotted lines in FIG. 6).

In general, the role of the microcontroller 26 could also be taken over by the DSP 22. Also, signal transmission could be limited to a pure audio signal, without adding control and command data.

In FIG. 7, an example of a system for enhancement of speech in a room 90 is schematically shown. The system comprises a microphone arrangement 44 for capturing audio signals from the voice of a speaker 11. The microphone arrangement 44 comprises at least two spaced apart microphones (not shown in FIG. 7) for achieving a directional pattern of the acoustic sensitivity. The audio signals are supplied to a unit 92 which may provide for pre-amplification of the audio signals and which, in case of a wireless microphone arrangement, includes a transmitter or transceiver for establishing a wireless audio link 12, such as an analog FM link or, preferably, a digital link. The microphone arrangement 44 and the unit 92 form part of a microphone assembly 10 which also comprises an acceleration sensor 48 and a control unit 50 for automatic shut-down during free-fall events of the transmission unit 10 as detected with the help of the acceleration sensor 48.

The audio signals are supplied, either by a wired connection 91 or, in case of a wireless microphone arrangement, via an audio signal receiver 61 to an audio signal processing unit 94 for processing the audio signals, in particular in order to apply a spectral filtering and gain control to the audio signals (alternatively, such audio signal processing, or at least part thereof, could take place in the unit 92). The processed audio signals are supplied to a power amplifier 96 operating at constant gain or at an adaptive gain (preferably dependent on the ambient noise level) in order to supply amplified audio signals to a loudspeaker arrangement 98 in order to generate amplified sound according to the processed audio signals, which sound is perceived by listeners 99.

The microphone assembly according to the present invention may be used not only with wireless hearing assistance systems or with speech enhancement systems, but also in applications like TV production, music studios, stage presentation and in broadcast, wherein microphones in usage in the field, like for interviews, for being passed around or on stage, may particularly benefit from the invention. In such applications, the microphone assembly often comprises a wired connection for supplying the audio signal output to an external audio system.

What is claimed is:

1. A mobile microphone assembly (10) comprising:
at least one microphone (40, 42) for generating an audio signal output (52) from sound impinging on the least one microphone,
an acceleration sensor (48) for sensing the acceleration acting on the microphone assembly with regard to three orthogonal axes and for providing for an acceleration signal according to the sensed acceleration, and
a control unit (50) for judging, by analyzing the acceleration signal, whether there is a drop-down event of the microphone assembly and for interrupting the audio signal output during a drop-down event.

2. The microphone assembly of claim 1, wherein the microphone assembly (10) is for capturing the voice of a user (11).

3. The microphone assembly of claim 2, wherein the microphone assembly (10) is a hand-held device.

4. The microphone assembly of claim 1, wherein the control unit (50) is designed to judge that there is a drop-down event once a given drop-down threshold acceleration is found to be exceeded by the acceleration signal for at least a given drop-down time period.

5. The microphone assembly of claim 1, wherein the control unit (50) is designed to judge that a drop-down event is terminated and to accordingly terminate interruption of the audio signal output once a release acceleration threshold is found to be not exceeded by the acceleration signal for at least a given release time period.

6. The microphone assembly of claim 1, wherein the control unit (50) is designed to short-circuit microphone wires for interrupting the audio signal output (52) during a drop-down event.

7. The microphone assembly of claim 1, further comprising means (28, 30, 92) for transmitting the audio signal output via a wireless link (12, 27) to at least one audio signal receiver unit (14, 61).

8. The microphone assembly of claim 7, wherein the wireless link is an FM link and wherein the control unit (50) is designed to cause the means for transmitting the audio signal output to interrupt modulation of the carrier waves during a drop-down event.

9. The microphone assembly of claim 7, wherein the wireless link is a digital link and wherein the control unit (50) is designed to cause the means for transmitting the audio signal output to interrupt transmission of audio data during a drop-down event.

10. The microphone assembly of claim 1, further comprising a wired connection (91) for supplying the audio signal output to an external audio system (94, 96, 98).

11. A system for speech enhancement in a room (90), comprising a microphone assembly (10) comprising:
at least one microphone (40, 42) for generating an audio signal output (52) from sound impinging on the least one microphone,
an acceleration sensor (48) for sensing the acceleration acting on the microphone assembly with regard to three orthogonal axes and for providing for an acceleration signal according to the sensed acceleration, and
a control unit (50) for judging, by analyzing the acceleration signal, whether there is a drop-down event of the microphone assembly and for interrupting the audio signal output during a drop-down event,
an audio signal processing unit (94) for processing the audio signal output (52) of the microphone assembly, and
a loudspeaker arrangement (98) for generating sound according to the processed audio signals.

12. A system for providing sound to at least one user (99), comprising the microphone assembly (10) comprising:
at least one microphone (40, 42) for generating an audio signal output (52) from sound impinging on the least one microphone,
an acceleration sensor (48) for sensing the acceleration acting on the microphone assembly with regard to three orthogonal axes and for providing for an acceleration signal according to the sensed acceleration, and
a control unit (50) for judging, by analyzing the acceleration signal, whether there is a drop-down event of the microphone assembly and for interrupting the audio signal output during a drop-down event,
wherein the microphone arrangement comprises an audio signal transmission unit (10) for transmitting the audio signals via a wireless link (12, 27), at least one receiver unit (14, 61) for reception of audio signals from the transmission unit via the wireless link; and means (16, 98) for stimulating the hearing of the user(s) according to an audio signal supplied from the receiver unit.

13. A method for capturing audio signals from sound, comprising the steps of:
generating, by at least one microphone (40, 42) of a mobile microphone assembly (10), an audio signal output (52) from sound impinging on the microphone,
sensing, by an acceleration sensor (48) of the mobile microphone assembly, the acceleration acting on the microphone assembly with regard to three orthogonal axes and providing an acceleration signal corresponding to the sensed acceleration, and
judging, by analyzing the acceleration signal, whether there is a drop-down event of the microphone assembly and interrupting the audio signal output during a drop-down event.
